(19) United States
(12) Patent Application Publication
(10) Pub. No.: US 2014/0325125 A1
(43) Pub. Date: Oct. 30, 2014

(54) ATOMIC WRITE METHODS

(71) Applicant: Samsung Electronics Co., Ltd., Suwon-si (KR)

(72) Inventors: MOON SANG KWON, SEOUL (KR); JONG HYUN YOON, SEOUL (KR); HYUNG JIN IM, HWASEONG-SI (KR); SANG HOON CHOI, SEOUL (KR)

(73) Assignee: Samsung Electronics Co., Ltd., Suwon-si (KR)

(21) Appl. No.: 14/262,834

(22) Filed: Apr. 28, 2014

(30) Foreign Application Priority Data
Apr. 29, 2013 (KR) 10-2013-0047770

(51) Int. Cl. G06F 3/06; G06F 5/10

(52) U.S. Cl. CPC G06F 3/0656; G06F 5/10; G06F 3/0679; G06F 3/0619
USPC 711/103; 710/52

(57) ABSTRACT

A method of transmitting atomic write data from a host to a data storage device in a data system includes; communicating a header identifying a plurality of data chunks associated with an atomic write operation from the host to the data storage device and storing the header in a buffering area designated in the data storage device, then successively communicating the plurality of data chunks from the host to the data storage device and successively storing the each one of the plurality of data chunks in the buffering area, and then storing write data including at least the plurality of data chunks in a first area of storage media in the data storage device.

### CROSS-REFERENCE TO RELATED APPLICATIONS

This application claims priority under 35 U.S.C. §119(a) from Korean Patent Application No. 10-2013-00477770 filed Apr. 29, 2013, the subject matter of which is hereby incorporated by reference.

### BACKGROUND

The inventive concepts relates generally to data storage systems and methods of performing an atomic write operation in same.

An atomic write or an atomic write operation is a write operation satisfying an all or nothing condition in relation to a given body of write data. This write data may be initially presented as disparate and logically unrelated “data chunks”. For instance, when the power applied to a data storage device is interrupted during an uncompleted write operation, and then the power is re-applied to thereby resume the uncompleted write operation—an atomic write operation may be required. This requirement stems from a necessity of data coherency wherein the data storage device must satisfy an all or nothing condition regarding the write data associated with the interrupted write operation. This can be a real challenge when the write data associated with the interrupted write operation is variously stored in different physical memory locations.

### SUMMARY

According to one embodiment of the inventive concept, there is provided a method of transmitting atomic write data from a host to a data storage device in a data system, the method comprising; communicating a header identifying a plurality of data chunks associated with an atomic write operation from the host to the data storage device and storing the header in a buffering area designated in the data storage device, and thereafter, successively communicating the plurality of data chunks from the host to the data storage device and successively storing the each one of the plurality of data chunks in the buffering area, and thereafter, storing write data including at least the plurality of data chunks in a first area of storage media in the data storage device.

According to another embodiment of the inventive concept, there is provided a method of transmitting atomic write data from a host to a data storage device in a data system, the method comprising; setting up a buffering area in the data storage device, receiving in the data storage device a header identifying a plurality of data chunks associated with an atomic write operation from the host, and thereafter, successively receiving the plurality of data chunks in from the host and successively storing the each one of the plurality of data chunks in the buffering area, and thereafter, storing write data including at least the plurality of data chunks in a first area of storage media in the data storage device.

### BRIEF DESCRIPTION OF THE DRAWINGS

Certain embodiments of the inventive concept are illustrated in the accompanying drawings in which:

FIG. 1 is a block diagram illustrating a data system according to an embodiment of the inventive concept;

FIG. 2 is a conceptual diagram illustrating a software hierarchy for a data system capable of performing am atomic write operation without materially altering use of a conventional operating system;

FIG. 3 is an exemplary coded listing for one embodiment of an application programming interface (API) that may be used in conjunction with an embodiment of the inventive concept;

FIG. 4 is a conceptual diagram illustrating execution of an atomic write operation using the API of FIG. 3;

FIGS. 5 and 6 are related conceptual diagrams illustrating data flow during an atomic write operation executed in a data system according to an embodiment of the inventive concept;

FIGS. 7 and 8 are respective conceptual diagrams illustrating various data flow during atomic write operation(s) executed in data system(s) according to an embodiment of the inventive concept;

FIG. 9 is a general flow chart summarizing an atomic write operation executed between a host and a data storage device in the data system of FIG. 1; and

FIGS. 10, 11, 12 and 13 are respective block diagrams illustrating data systems according to various embodiments of the inventive concept.

### DETAILED DESCRIPTION OF EMBODIMENTS

Certain embodiments of the inventive concepts will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

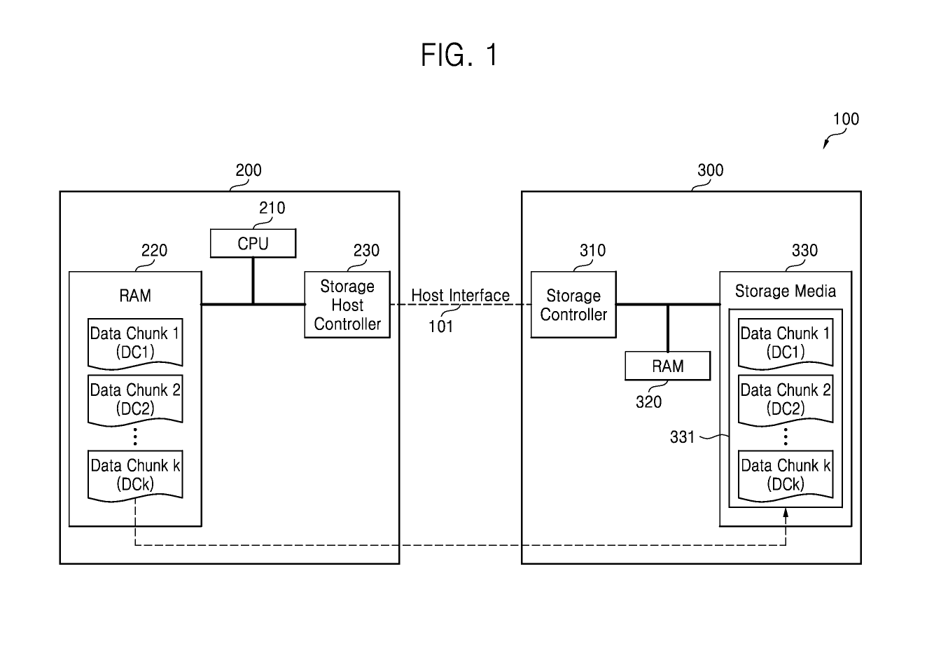

FIG. 1 is a block diagram illustrating a data storage system (hereafter, “system”) according to an embodiment of the inventive concept. Referring to FIG. 1, the system 100 is configured to execute an “atomic write operation” and generally includes a storage host 200 and a data storage device 300 connected via a host interface 101.

The system 100 may take one of many different physical forms, such as a personal computer (PC), a server (e.g., a data server or web server), a portable electronic device (e.g., a laptop computer, mobile phone, smart phone, tablet PC, personal digital assistant (PDA), enterprise digital assistant (EDA), digital still camera, digital video camera, portable multimedia player (PMP), personal or portable navigation device (PND), handheld game console, mobile internet device (MID), e-book, etc.).

In the illustrated embodiment of FIG. 1, the host 200 comprises a central processing unit (CPU) 210, a first memory (e.g., a random access memory or RAM) 220, and a storage host controller 230. The data storage device 300 comprises a storage controller 310, a second memory (RAM) 320, and storage media 330.

In the foregoing context, an atomic write operation is one in which disparate “data chunks” (e.g., block(s) of data, set(s) of data, one or more bytes of data, etc.) are gathered together to form a collective body of “write data” that is communicated between the host 200 and data storage device 300 via the host interface 101. For example, “k” data chunks (DC1 through DCk), where k is a positive integer, may be gathered from disparate locations within the first memory 220 by CPU 210 in order to form a body of write data. The write data is then communicated from the storage host controller via the host interface to the storage controller of the data storage device 300. And in addition to being gathered into a single, unitary body of write data for communication purposes, the respective data chunks DC1 through DCk may be written (or programmed) to a storage area 331 of the storage media 330 atomically (i.e., as a contiguous body of write data). This may be done whether the storage area 331 extends across one or more physical memory boundaries for embodiments wherein the storage media 330 is implemented using more than one data storage unit (i.e., separate integrate circuits).

Thus, the CPU 210 may be understood as a control circuit capable of controlling the overall operation of the host 200, regardless of any other functional capabilities. In certain embodiments of the inventive concept, the CPU 210 may be a processor or a multi-core processor.

The first memory 220 of the host 200 may be used to store all or some of the data chunks DC1 through DCk forming the body of write data. In certain embodiments of the inventive concept, the first memory 220 may be a volatile memory device, such as a dynamic RAM (DRAM), static RAM (SRAM), thyristor RAM (T-RAM), zero capacitor RAM (Z-RAM), or Twin Transistor RAM (RRRAM). In other embodiments of the inventive concept, the first memory 220 may be a non-volatile memory device, such as a read only memory (ROM), electrically erasable programmable ROM (EEPROM), NOR flash memory, NAND flash memory, Magnetic RAM (MRAM), spin-transfer torque MRAM (STT-MRAM), conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, molecular electronics memory device, or insulator resistance change memory.

In certain other embodiments of the inventive concept, the first memory 220 may be a non-volatile memory device such as a hard disk drive (HDD) or a solid state drive (SSD).

The storage host controller 230 may be used to control the communication of write data from the host 200 to the data storage device 300 under the control of the CPU 210. The CPU 210, first memory 220, and storage host controller 230 may communicate with one another via an interconnect (e.g., one or more bus(es)).

In certain embodiments of the inventive concept, the data storage device 300 may further include a CPU (not shown) that controls the overall operation of the data storage device 300, and the inter-operation of the storage controller 310, second memory 320, and storage media 330. In this regard, the storage controller 310, second memory 320, and the storage media 330 may communicate with one another via an interconnect (e.g., one or more bus(es)).

The storage controller 310 may be used to facilitate communication between the host 200 and the data storage device 300. For example, the storage controller 310 may in conjunction with the CPU 210 of the host 200 be used to facilitate the execution of an atomic write operation, wherein the atomic write operation may be executed as part of a transaction write operation performed by the host 200 that stores a body of write data in a buffering area of the storage media 330 in a single operation.

The second memory 320 may be embodied as a volatile memory device as described above in relation to the first memory 220. The storage media 330 may be embodied as one or more volatile memory device(s) and/or one or more non-volatile memory device(s) as described above. For example, the data storage device 300 may be embodied into a data base, SSD, universal flash storage (UFS), flash universal serial bus (USB) drive, secure digital (SD) card, multimedia card (MMC), embedded MMC, smart card, or memory card.

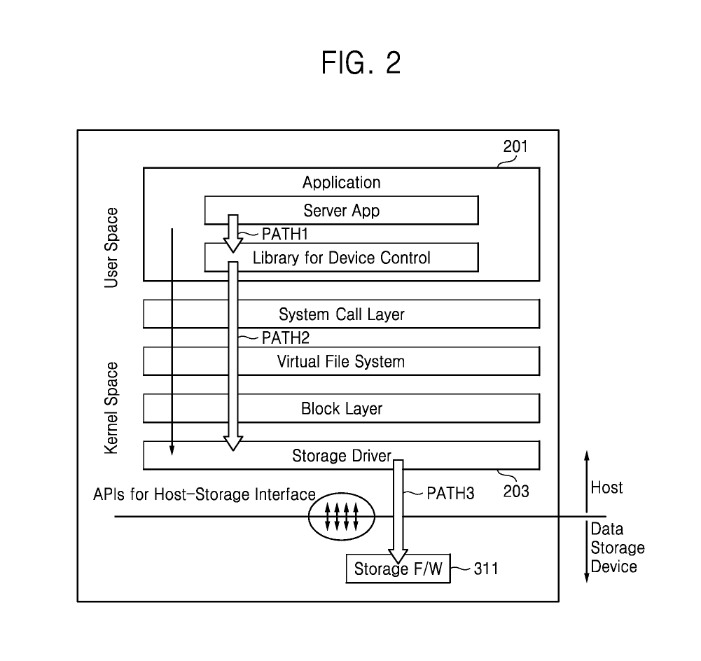

FIG. 2 is a conceptual diagram for explaining a method for transmitting a request for atomic write to a storage without changing each layer of the conventional operating system (OS).

FIG. 2 conceptually illustrates a hierarchy of related software components that may cooperate to cause tot eh execution of an atomic write operation. Such software components may include, for example, an application 201 running on the host 200 that communicates an atomic write request invoking the execution of an atomic write operation by the data storage device 300. That is, the application 201 may cause the atomic write request to be communicated via a corresponding storage driver 203 and application programming interface (API) to the data storage device. Thus, the API connecting the storage driver 203 with the data storage device firmware 311 may be understood as a data tunnel or a third data path (PATH3) in relation to a first data path (PATH1) between the server application and library for device control (e.g., user space) of the application 201, and a second data path (PATH2) through kernel space extending across a system calls layer, virtual file system, block layer to the storage driver 203.

Given this exemplary configuration of components, the application 201 may directly communicate an atomic write request to the storage drive 203 via PATH 1 and PATH 2. The storage driver 203 may then communicate instructions, address(es), and/or data associated with the atomic write request to the data storage device firmware 311 via PATH 3. For example, the storage driver 203 may communicate write data related to an atomic write request to the storage controller 310 of the data storage device 300 via the storage host controller 230, where the data storage device firmware 311 controls the operation of the storage controller 310.

It will be understood by those skilled in the art that the host 200 and data storage device 300 will communicate via the host interface 101 using one or more data communication protocol(s). For example, the host interface 101 may support a serial advanced technology attachment (SATA) protocol or a serial attached SCSI (SAS) protocol.

Given the exemplary hierarchy of software components illustrated in FIG. 2, it will be understood that certain conventional operating systems (OS) may not be capable of executing an atomic write operation of the kind described above. Further, in order to implement an atomic write operation in various embodiments of the inventive concept including such a conventional OS, it would be necessary to modify each and every one of the software components extending between the application 201 and storage driver 203. That is, an API capable of executing an atomic write request would be required for each software layer of a conventional OS (e.g., the system call layer, virtual file system, and block layer).

However, when the application 201 is properly designed to facilitate execution of an atomic write operation according to embodiments of the inventive concept, an atomic write request directed to the storage driver 203 may be efficiently communicated via the second data path (PATH2) without necessarily changing each and every software layer of a conventional OS. And in response to the atomic write request received from the application 201, the storage driver 203 will communicate write data related to the atomic write request including an appropriate data header and identified data chunks to the data storage device 300.

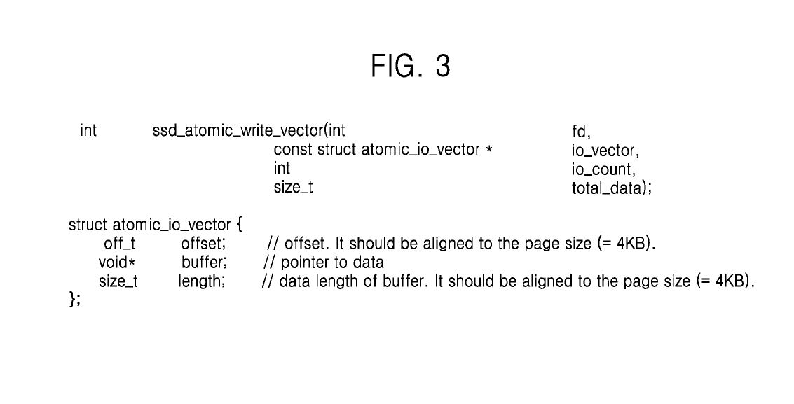

FIG. 3 is coding language that, in part, illustrates one example of an application programming interface (API) that may be incorporated in certain embodiments of the inventive concept.

Extending the working example of FIGS. 1 and 2, the application 201 running on host 200 is assumed to issue an atomic write request directed to the writing of certain gathered data chunks to the data storage device 300 using the API illustrated in FIG. 3. Here, the label ‘fd’ denotes location(s) in the storage area 331 to which the write data of an atomic write operation (e.g., including data chunks DC1 through DCk) are to be written. For example, the respective data chunk may be retrieved from the first memory 220 and written to the storage media 330 using successive sector addresses.

It is assumed that that data read/write operations directed to the storage are 331 are defined by sector units (e.g., 512-byte sector units). Thus, further assuming a write data size of “N”, each sector of write data to be stored in the data storage device 300 may be accessed according to a corresponding (sequential) sector number.

Referring again to FIG. 3, the write data, including both data chunks and related header information identifying location(s) to which the respective data chunks are to be written, is stored in ‘io_vector’ using an array data form. The variable ‘io_count’ is a number of data chunks to be written from the write data. The variable ‘total_data’ is value indicating the length of the write data, but this variable is optional and may or may not be included in the illustrated API.

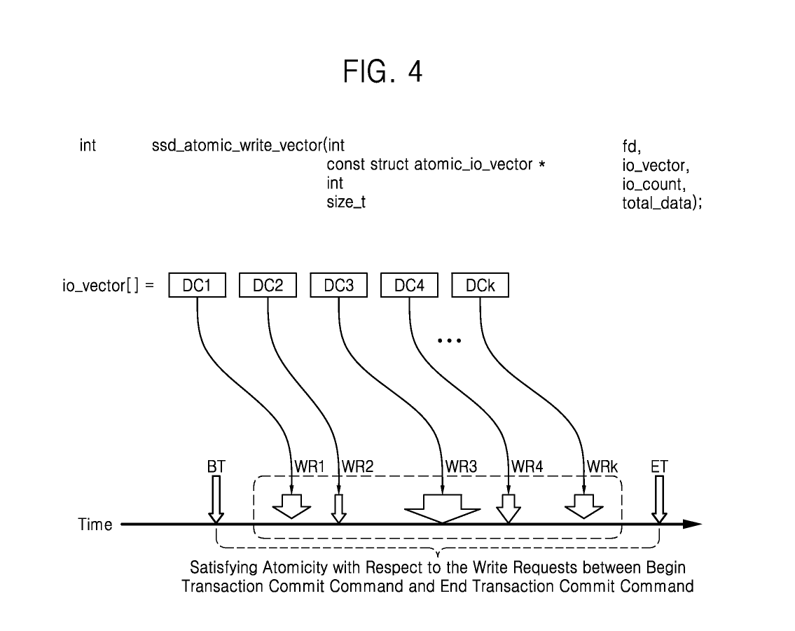

FIG. 4 is a conceptual diagram related to the exemplary API of FIG. 3. As noted above with respect to FIG. 3, it is assumed that ‘io_vector’ includes all write data and related information implicated in a given atomic write request. FIG. 4 further illustrates the write data as gathered from the first memory 220 using a unit storage area address (e.g., sector addresses), wherein ‘WR1 through WRk’ denote different storage areas respectively identified by a different sector address.

In the example of FIG. 4, ‘BT’ denotes the beginning of transaction write (i.e., a begin transaction commit command) and ‘ET’ denotes the end of the transaction write (i.e., an end transaction commit command). Here, the term “transaction write” denotes a write operation communicating write data related to an atomic write operation from the host 200 to the data storage device 300.

As shown in FIG. 4, the illustrated atomic write operation satisfies “atomicity” with respect to the constituent write requests WR1 through WRk that are executed as part of the transaction write extending from the begin transaction commit command BT to the end transaction commit command ET. That is, the data chunks DC1 through DCk are written (i.e., transferred) from the first memory 220 of the host 200 to the storage area 331 of the data storage media 330 atomically.

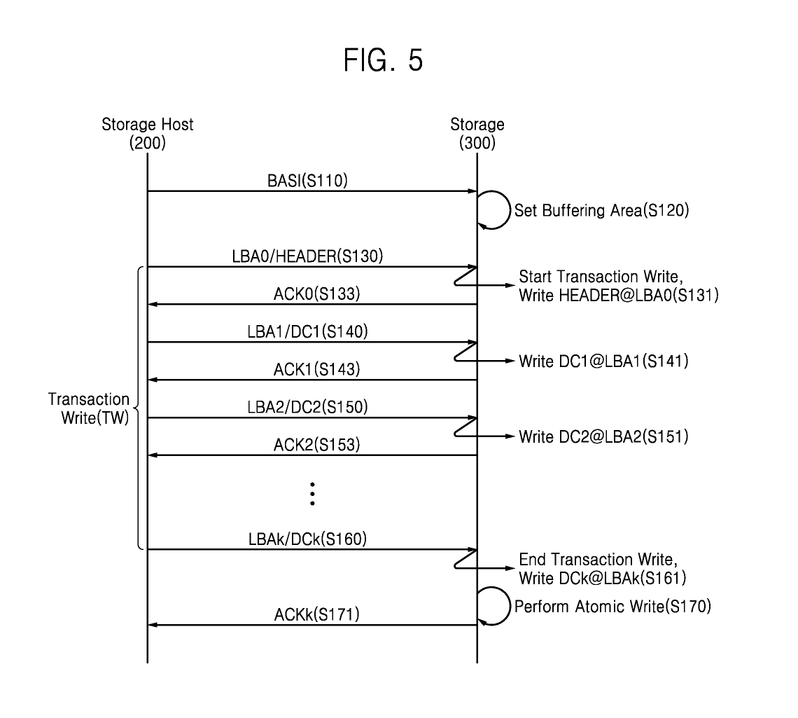

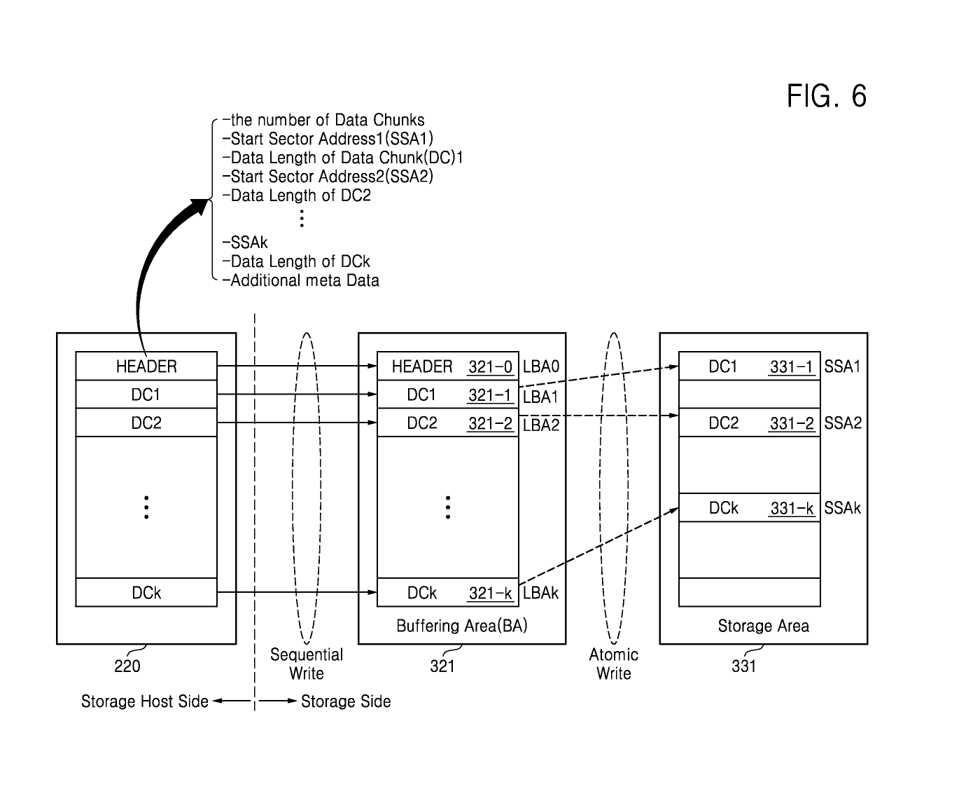

FIGS. 5 and 6 are related conceptual diagrams illustrating an exemplary data flow that further characterizes execution of an atomic write operation in a system according to an embodiment of the inventive concept.

The atomic structure of the constituent write data includes a header (HEADER) and respective data chunks DC1 through DCk that will be successively communicated from the host 200 to an identified “buffering area” (BA) of the data storage device 300.

The buffering area BA is a storage area to which data related to an atomic write, for example, a header (HEADER) and data chunks DC1 through DCk may be temporarily written. That is, the buffering area BA will be a different data storage area than the storage area 331 of storage media 330 that has been designated to atomically store at least the data chunks DC1 through DCk of the write data.

In certain embodiments of the inventive concept, the buffering area BA may be located in a different portion of the storage media 330 or is a separate memory (e.g., a buffer memory) external to the storage media 330. In the particular embodiment illustrated in FIG. 1, the buffering area BA may be located in the second memory 320 (e.g., a dynamic random access memory (DRAM)) and/or in a portion of the storage media 330 outside the storage area 331.

Referring collectively to FIGS. 1, 2, 3, 4, 5, and 6, the host 200 transmits information (e.g., BASI) designating (or setting) the buffering area BA in the data storage device 300 (S110). For example, buffering area setting information BASI provided by the host 200 may include start and stop addresses LBA0 through LBAk for the buffering area BA. Alternately, the buffering area setting information BASI may include a start location and size defining the buffer area BA. These determinations may be made in view of the size and/or type of the write data to be written during a following one or more atomic write operations.

The data storage device 300 then sets the designated buffering area BA based on the buffering area setting information BASI (S120).

At this point, the host 200 may communicate a start address LBA0 for the buffering area BA in conjunction with header (HEADER) information to the data storage device 300 (S130). The header (HEADER) will thus be stored beginning at the start address of the buffering area BA. Here, the start address LBA0 may be a sector address.

The header (HEADER) indicates a number of data chunks DC1 through DCk, each having a respective start address (e.g., SSA1 through SSAk) in the storage area 331-1 (e.g., 331-1 through 331-k). Each data chunk start address SSA1 through SSAk may be a start sector address, and the header (HEADER) may further include additional metadata.

In response to a write request including the write data start address LBA0 of the buffering area BA, the data storage device 300 may determine that the current write operation being requested by the host 200 is an atomic write operation directed to a gathered set of data chunks forming a body of atomic write data. In contrast, upon receipt of a write request lacking an address unrelated to the buffering area BA, the data storage device 300 may determine that a non-atomic write operation (e.g., a random write operation or a sequential write operation, hereafter denoted as a “normal write operation”) should be executed. In this manner, a same write request command format may be used by the host 200 for both normal write operations and atomic write operations, wherein only an address associated with the write request distinguishes between the two write operations types.

According to working embodiment described by FIGS. 1, 5 and 6, the storage controller 310 of the data storage device 300 may be used to determine from the received header (HEADER) information the nature of the requested write operation. Thus, with reference to FIG. 6, the storage controller 310 may determine from a received header (HEADER) written to a header area 321-0 of the buffering area BA that a current write request provided by the host 200 is an atomic write request, as the header area 321-0 corresponds to the beginning of the buffering area BA having the start address LBA0. In response, to this determination by the storage controller 310, the data storage device 300 executes an atomic write operation as a transaction write TW (S131).

The data storage device 300 then transmits a first acknowledgment response (ACK0) to the host 200 upon writing the header (HEADER) in the header area 321-0 (S133). The host 200 then transmits a first data chunk address LBA1 that corresponds to a location in the buffering area BA at which the first data chunk DC1 will be written (S140). The data storage device 300 then writes the first data chunk DC1 beginning at the first data chunk area 321-1 of the buffering area BA based on the address LBA1 (S141).

The storage 300 then communicates a second acknowledgement response (ACK1) to the host 200 upon writing the first data chunk DC1 in the first data chunk area 321-1 (S143).

The host 200 then communicates a second data chunk address LBA2 also corresponding to the buffering area BA and the second data chunk DC2 to the data storage device 300 (S150).

The data storage device 300 may then write the second data chunk DC2 to a second data chunk area 321-2 of the buffering area BA based on the address LBA2 (S151). Then, the data storage device 300 communicates a third acknowledgement response (ACK2) to the host 200 upon writing the second data chunk DC2 to the second data chunk area 321-2 (S153).

The host 200 continues in this manner to communicate respective data chunk addresses corresponding to the buffering area BA for each data chunk to be written to the data storage device 300 (S160), as the storage controller 310 continues to determine that received address and data chunk are part of an ongoing atomic write operation directed to a designated buffering area BA until the last data chunk DCk has been properly stored thereby completing the transaction write operation (S161).

Upon receipt and writing in the buffering are BA of the last data chunk DCk, the storage controller 310 then determines that the complete body of write data now stored in the buffering area BA may written (or programmed) as an atomic body of write data to the storage area 331 of the data storage device 300. It should be noted that during the atomic write operation, each one of the header (HEADER) and the respective data chunks DC1 through DCk forming the body of write data is successively written to a corresponding storage area 321-0 through 321-k in the buffering area BA. Then, upon completion of the transaction write TW portion of the atomic write operation with respect to the buffering area BA, the data storage device 300 will cause the data chunks DC1 through DCk temporarily stored in the buffering area to be atomically written to the storage area 331. That is, the first data chunk DC1 stored in the buffering area BA is written to a unit storage area 331-1 designated by a start address SSA1, the second data chunk DC2 stored in the buffering area BA is written to a unit storage area 331-2 designated by a start address SSA2, and the k^{th} data chunk DCk stored in the buffering area BA is written to a unit storage area 331-k designated by a start address SSAk.

Each of the unit storage area 331-1 through 331-k may be physically adjacent one to another or non-adjacently dispersed in the storage area 331.

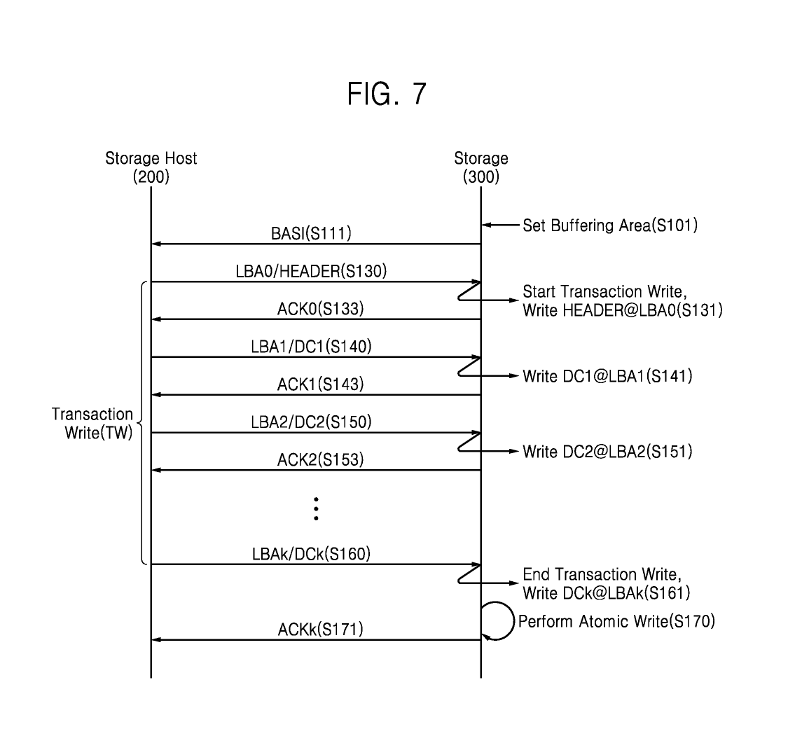

FIG. 7 is another conceptual diagram illustrating data flow during an atomic write operation performed by a data system according to an embodiment of the inventive concept.

Referring to FIG. 7, a buffering area BA is set by the data storage device 300 according (S101), buffering area setting information BASI including addresses LBA0 through LBAk defining the buffering area BA is communicated to the host 200 by the storage 300 (S111). In certain embodiments of the inventive concept, the buffering area BA may be set as a particular default by a manufacturer of the data storage device.

When gathered atomic write data is required, the host 200 may communicate such data using an atomic write operation. That is, a header (HEADER) and data chunks DC1 through DCk, may be successively communicated to the data storage device 300 during a particular transaction write operation using a designated buffering area BA of the data storage device 300.

During the transaction write TW, each of the header (HEADER) and the data chunks DC1 through DCk is written to each storage area 321-0 through 321-k of the buffering area BA successively. Each storage area 321-0 through 321-k may be a buffering area adjacent to each other based on a local block address LBA. Each of the data chunks DC1 through DCk stored to each storage area 321-0 through 321-k of the buffering area BA successively is stored to each unit storage area 331-1 through 331-k of the storage area 331 of the storage media 330 atomically during the atomic write.

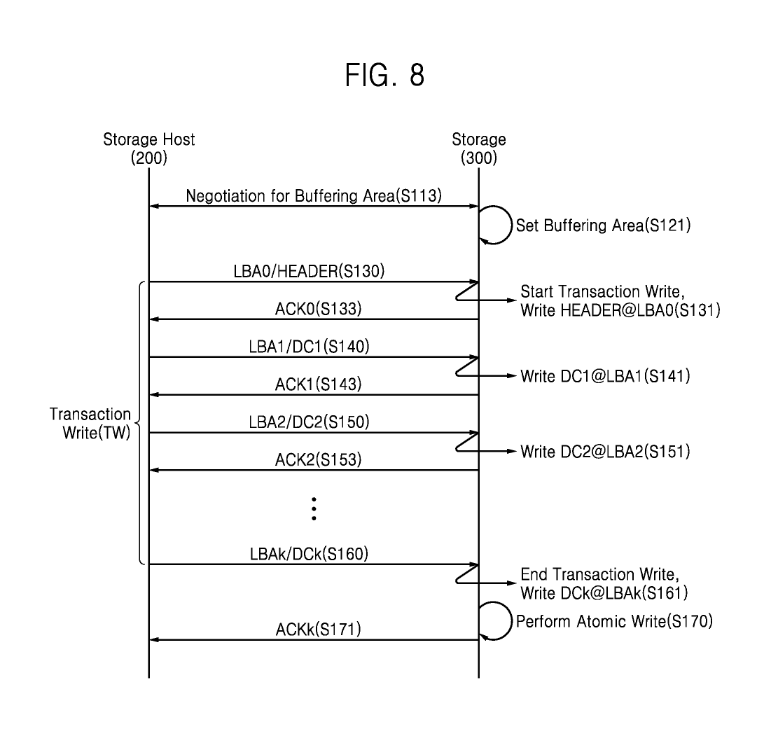

FIG. 8 is still another conceptual diagram illustrating data flow during another atomic write operation performed by a data system according to an embodiment of the inventive concept. Here, the size and nature of the buffering area BA is determined through a negotiation of sorts between the host 200 and data storage device 300 (S113). The data storage device 300 then sets an agreed upon buffering area BA following completion of the negotiation (S121).

During the transaction write TW, each of the header (HEADER) and the data chunks DC1 through DCk is written to each storage area 321-0 through 321-k of the buffering area BA.

Each of the data chunks DC1 through DCk stored in each storage area 321-0 through 321-k successively is written to each unit storage area 331-1 through 331-k of the storage area 331 of the storage media 330 atomically.

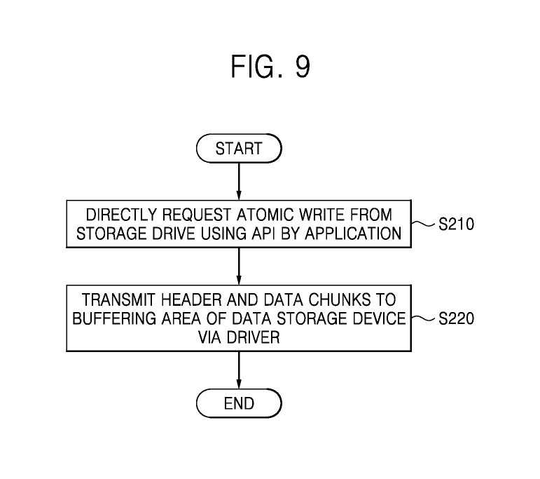

FIG. 9 is a flow chart generally summarizing operation of a data system in response to an atomic write request issued by a host in the data system. Referring to FIGS. 1 and 2, for example, the application 201 may directly communicate an atomic write request to the storage driver 203 via the API (S210).

The storage driver 203 may then successively communicate a header (HEADER) and data chunks DC1 through DCk, such that the header (HEADER) and data chucks DC1 through DCk identified by the atomic write request are written to the buffering area BA of the data storage device 300 (S220).

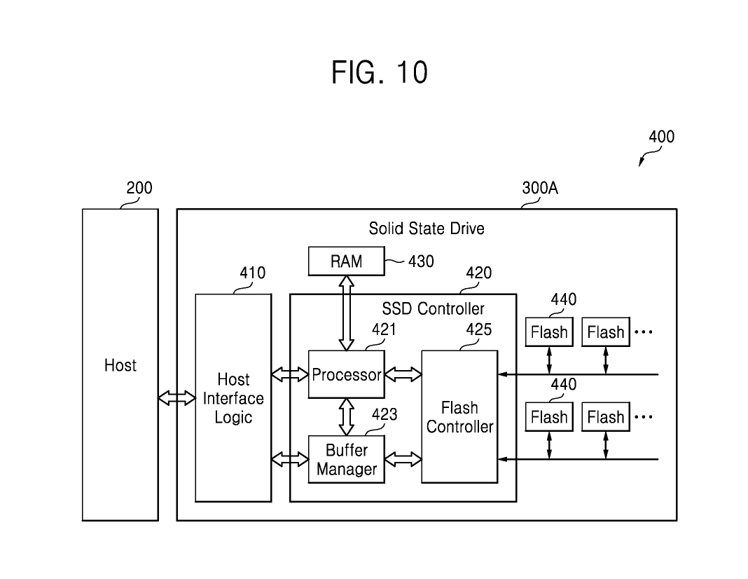

FIGS. 10, 11, 12 and 13 are respective block diagrams of data systems according to various embodiments of the inventive concept. Referring to FIG. 10, a data system 400 includes a host 200 and a solid state drive (SSD) 330A.

The SSD 300A includes a host interface logic 410, an SSD controller 420, a storage device 430, and flash memory devices 440. The storage device 430 may be embodied into the above-identified volatile memory device or the above-identified non-volatile memory device.

The host interface logic 410 interfaces data exchanged by the host 200 and the SSD controller 420. The SSD controller 420 controls data exchanged among the host interface logic 410, the storage device 430, and the flash memory devices 440.

The SSD controller 420 includes a processor 421, a buffer manager 423, and a flash controller 425.

The processor 421 controls the operation of the SSD controller 420 generally. For example, the processor 421 controls the operation of the buffer manager 423 and the flash controller 425. The buffer manager 423 controls buffering of data exchanged between the host interface logic 410 and the flash controller 425.

The flash controller 425 controls data exchanged between the flash memory devices 440 and the buffer manager 423. The buffering area BA may be embodied in at least one of the flash memory devices 440 or the storage device 430.

At least one of the flash memory devices 440 performs a function of the storage area 331 for writing data chunks DC1 through DCk stored in the buffering area BA atomically.

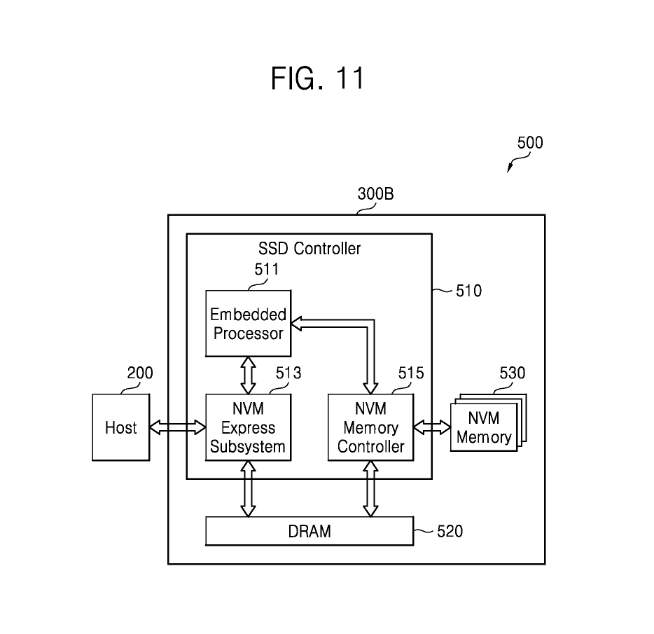

Referring to FIG. 11, a data system 500 includes a host 200 and a storage 300B. The storage 300B includes an SSD controller 510 supporting a non-volatile memory express (NVMe), a storage device 520, and non-volatile memories 530.

The SSD controller 510 includes an embedded processor 511, an NVM express sub system 513, and an NVM memory controller 515.

The embedded processor 511 controls the operation of an NVM express sub system 513 and an NVM memory controller 515. The NVM express sub system 513 receives and processes data related to the atomic write output from the host 200.

Each of the NVM express sub system 513 and the NVM memory controller 515 accesses the storage device 520. The storage device 520 may be embodied into a volatile memory such as dynamic random access memory (DRAM).

The buffering area BA may be embodied in at least one of the non-volatile memories 530 or storage device 520. According to the control of the NVM memory controller 515, data related to the gathered atomic write written to the buffering area BA is written to at least one of the non-volatile memories 530 atomically.

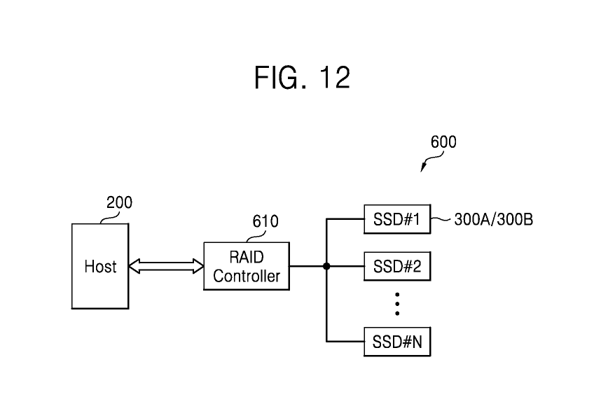

Referring to FIG. 12, a data system 600 includes a host 200, a redundant array of independent disks (RAID) controller 610, and a plurality of SSDs 300A or 300B. A buffering area BA may be embodied in at least one of the plurality of SSDs 300A or 300B. Data related to the gathered atomic write written to the buffering area BA is written to at least one of the plurality of SSDs 300A or 300B atomically.

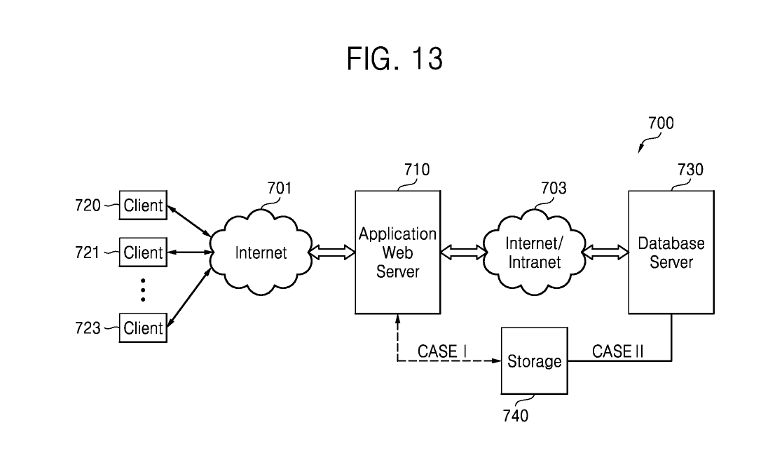

Referring to FIG. 13, a system 700 includes an application web server 710, a plurality of clients 720 through 723, and a storage 740. The application web server 710 and the plurality of clients 720 through 723 form a communication network through the internet 701.

The application web server 710 performs a function of the host 200, and the storage 740 performs a function of the storage 300.

According to a case1 (CASE I), the application web server 710 transmits data related to the gathered atomic write to the buffering area of the storage 740 through transaction write, and the storage 740 writes data stored in the buffering area to the storage media atomically.

According to a case II (CASE II), the system 700 further includes a database server 730. At this case, the application web server 710 and the database server 730 may be connected through the internet or intranet 703.

At this time, the data base server 730 performs a function of the host 200, and the storage 740 performs a function of the storage 300. Thus, the data base server 730 transmits data related to the gathered atomic write to the buffering area of the storage 740 through the transaction write, and the storage 740 writes data stored in the buffering area to the storage media atomically.

The method for atomic write according to an embodiment has an effect of transmitting atomic write data related to the atomic write from the host to the storage. The method for atomic write transmits the atomic write data related to the atomic write without changing layers of the conventional operating system (OS) from the host to the storage, thereby improving executing speed of application related to the transmitting of the data and increasing the lifespan of the storage.

While the present invention has been particularly shown and described with reference to embodiments thereof, it will be understood that various changes in form and details may be made therein without departing from the scope of the following claims.

What is claimed is:

1. A method of transmitting atomic write data from a host to a data storage device in a data system, the method comprising:
communicating a header identifying a plurality of data chunks associated with an atomic write operation from the host to the data storage device and storing the header in a buffering area designated in the data storage device; and thereafter,
successively communicating the plurality of data chunks from the host to the data storage device and successively storing the each one of the plurality of data chunks in the buffering area; and thereafter,
storing write data including at least the plurality of data chunks in a first area of storage media in the data storage device.

2. The method of claim 1, wherein the data storage device comprises a volatile Random Access Memory (RAM), the storage media comprises at least one nonvolatile semiconductor memory device, and the buffering area is located in the RAM

3. The method of claim 1, wherein the storage media comprises at least one nonvolatile semiconductor memory device, and the buffering area is a second area of storage media other than the first area.

4. The method of claim 3, wherein storing the write data in the first area of storage media comprises successively and adjacently storing each one the plurality of data chunks in the first area.

5. The method of claim 3, wherein storing the write data in the first area of storage media comprises successively and randomly storing each one the plurality of data chunks in the first area.

6. The method of claim 1, wherein the header comprises information identifying a number of the plurality of data chunks, and information indicating a respective length for each one of the plurality data chunks.

7. The method of claim 6, wherein the header further comprises a start address for the buffering area, and information indicating a size of the buffering area.

8. The method of claim 6, wherein the header further comprises a start address for the buffering area and a stop address for the buffering area.

9. The method of claim 1, wherein the data storage device comprises a storage controller that receives the header and sets up the buffering area in response to the header.

10. The method of claim 9, wherein the header comprises at least one of information identifying a number of the plurality of data chunks, information indicating a respective length for each one of the plurality data chunks, a start address for the buffering area, information indicating a size of the buffering area, an a stop address for the buffering area.

11. A method of transmitting atomic write data from a host to a data storage device in a data system, the method comprising:
setting up a buffering area in the data storage device;
receiving in the data storage device a header identifying a plurality of data chunks associated with an atomic write operation from the host; and thereafter,
successively receiving the plurality of data chunks in from the host and successively storing the each one of the plurality of data chunks in the buffering area; and thereafter,
storing write data including at least the plurality of data chunks in a first area of storage media in the data storage device.

12. The method of claim 11, wherein setting up the buffering area in the data storage device comprises determining from the header a start address and a size of the buffering area.

13. The method of claim 11, wherein setting up the buffering area in the data storage device comprises determining from the header a start address and a stop address for the buffering area.

14. The method of claim 11, wherein setting up the buffering area in the data storage device comprises performing a negotiation between the host and data storage device to define a size and location of the buffering area.

15. The method of claim 11, further comprising:
after setting up the buffering area in the data storage device, communicating buffering area setting information to the host, wherein the buffering area setting information defines the location and size of the buffering area.

16. The method of claim 15, wherein the data storage device comprises a volatile Random Access Memory (RAM), the storage media comprises at least one nonvolatile semiconductor memory device, and the buffering area is located in at least one of the RAM and a second area of storage media other than the first area.

17. The method of claim 16, wherein storing the write data in the first area of storage media comprises successively and adjacently storing each one the plurality of data chunks in the first area.

18. The method of claim 16, wherein storing the write data in the first area of storage media comprises successively and randomly storing each one the plurality of data chunks in the first area.
